(19) United States
(12) Patent Application Publication
(10) Pub. No.: US 2023/0142434 A1
(43) Pub. Date: May 11, 2023

(54) FACE MASK APPARATUS WITH SECONDARY FILTER

(71) Applicant: O2 INDUSTRIES INC., Kitchener (CA)

(72) Inventors: Richard Devin SZASZ, Kitchener (CA); Norrie Tienlor SHENG, Waterloo (CA); Peter Lionel WHITBY, Waterloo (CA); Steven Henry Fyke, Toronto (CA); Matthew Gerald HEXEMER, Minesing (CA); Victor Bogatch, Scarborough (CA); Kevin Martin ARMOUR, Toronto (CA)

(21) Appl. No.: 17/907,519

(22) PCT Filed: Mar. 26, 2021
(86) PCT No.: PCT/CA2021/050394

§ 371 Date: Sep. 27, 2022

Related U.S. Application Data
(60) Provisional application No. 63/001,030, filed on Mar. 27, 2020.

(51) Int. Cl. A62B 18/02; A62B 23/02; A62B 18/08

(52) U.S. Cl. CPC A62B 18/025; A62B 23/025; A62B 18/08

(57) ABSTRACT

A face mask apparatus for filtering air, the face mask apparatus including a primary face mask having a face seal for providing an airtight flexible seal around the nose and mouth of the user; a support sealably attached to the face seal, wherein the support has an open area that allows for passage of incoming air; a front shell for removably attaching to the support, wherein the front shell has at least one inlet hole for allowing the incoming air to pass through the open area of the support; a filter for filtering particulate elements from air, wherein the filter is configured to be housed between the front shell and the support, and the face seal provides a direct connection between the filter and the user; and a receiver projecting from an exterior surface of the front shell for receiving a secondary mask.

### TECHNICAL FIELD

The disclosure relates to face masks, and in particular to face masks including a primary filter and for use with a removable secondary filter.

### BACKGROUND

Face masks are used in a wide variety of applications to protect a respiratory system from particles or gases in the air. Such masks include filter masks which are commonly worn by persons who are in polluted environments in an effort to protect themselves from inhaling airborne contaminants. Filter masks typically have a fibrous or sorbent filter that is capable of removing particulate and/or gaseous contaminants from the air.

An example of a filter mask is disclosed in Patent Application Publication WO 2018/045456 filed by the present Applicant. The filter mask includes a face seal for providing an airtight flexible seal around the nose and mouth of a user, a support sealably attached to the face seal, wherein the support has an open area that allows for passage of incoming air and outlet valves for expelling exhaled air, a front shell for removably attaching to the support, wherein the front shell has inlet holes for allowing the incoming air to pass through the open area of the support, and a filter for filtering particulate elements from air. The filter is configured to be housed between the front shell and the support. The face seal provides a direct connection between the filter and the user.

Some users of filter masks may need to replace a filter and/or filter mask while remaining in a potentially hazardous environment. For example, medical personnel may need to replace a mask and/or filter when exiting a first room and prior to entering a second room to avoid carrying contaminants from the first room to the second room on the mask and/or filter. Medical personnel may need to replace a mask while remaining in a potentially hazardous environment. For example, medical personnel may need to replace a mask in a hallway between a first room and a second room, even when there is a risk that an airborne contaminant may be in the hallway. Medical personnel may be exposed to an airborne contaminant while replacing a mask.

There is accordingly a need for an improved face mask that addresses at least one of the above concerns.

### SUMMARY

According to a first aspect, there is provided a face mask apparatus for filtering air, the face mask apparatus comprising a face seal for providing an airtight flexible seal around the nose and mouth of the user; a support sealably attached to the face seal, wherein the support has an open area that allows for passage of incoming air and outlet valves for expelling exhaled air; a front shell for removably attaching to the support, wherein the front shell has at least inlet holes for allowing the incoming air to pass through the open area of the support; a filter for filtering particulate elements from air, wherein the filter is configured to be housed between the front shell and the support, and the face seal provides a direct connection between the filter and the user; and a receiver projecting from an exterior surface of the front shell for receiving a secondary mask.

In some embodiments, the receiver includes a mounting feature for mounting the secondary mask to the front shell.

In some embodiments, the receiver includes a standoff for maintaining an airflow gap between the exterior surface of the front shell and the secondary mask.

In some embodiments, the receiver includes a receiver seal for providing an airtight flexible seal between the secondary mask and the exterior surface of the front shell around the inlet holes.

In some embodiments, the receiver seal is a continuous flexible raised periphery.

According to a second aspect, there is provided a face mask apparatus for filtering air, the face mask apparatus comprising a face seal for providing an airtight flexible seal around the nose and mouth of the user; a support sealably attached to the face seal, wherein the support has an open area that allows for passage of incoming air; a front shell for removably attaching to the support, wherein the front shell has at least one inlet hole for allowing the incoming air to pass through the open area of the support; a filter for filtering particulate elements from air, wherein the filter is configured to be housed between the front shell and the support, and the face seal provides a direct connection between the filter and the user; and a receiver projecting from an exterior surface of the front shell for receiving a secondary mask.

According to a third aspect, there is provided a face mask apparatus for filtering air, the face mask apparatus comprising a face seal for providing an airtight flexible seal around the nose and mouth of the user; a support sealably attached to the face seal, wherein the support has an open area that allows for passage of incoming air; a front shell for removably attaching to the support, wherein the front shell has at least one inlet hole for allowing the incoming air to pass through the open area of the support; a filter for filtering particulate elements from air, wherein the filter is configured to be housed between the front shell and the support, and the face seal provides a direct connection between the filter and the user; and a secondary filter releasably secured to an exterior surface of the front shell and disposed upstream of the at least one inlet hole to pre-filter an air flow entering the inlet hole.

In some embodiments, the secondary filter is a compression molded filter mask.

According to a fourth aspect, there is provided a filtration method, comprising applying a face mask apparatus to a face of a user, the face mask apparatus including a primary face mask to cover a nose and a mouth of the user and having a face seal for providing an airtight flexible seal around the nose and mouth of the user, the face mask apparatus including an inhalation passage through the face mask apparatus, a primary filter received in the inhalation passage to filter air passing through the inhalation passage; applying, while maintaining the face mask apparatus on the face of the user and the primary filter in the inhalation passage to filter air passing through the inhalation passage, a first secondary filter to the face mask apparatus to filter air prior to the air passing through the inhalation passage; removing, while maintaining the face mask apparatus on the face of the user and the primary filter in the inhalation passage to filter air passing through the inhalation passage, the first secondary filter and disposing of the first secondary filter; and applying, while maintaining the face mask apparatus on the face of the user and the primary filter in the inhalation passage to filter air passing through the inhalation passage, a second secondary filter to the face mask apparatus to filter air prior to the air passing through the inhalation passage.

In some embodiments, applying the first secondary filter to the face mask apparatus includes covering a forward exterior surface of the face mask apparatus with the first secondary filter.

In some embodiments, applying the second secondary filter to the face mask includes covering the forward exterior surface of the face mask apparatus with the second secondary filter.

### BRIEF DESCRIPTION OF THE DRAWINGS

The drawings included herewith are for illustrating various examples of systems, methods, and apparatus of the present specification. In the drawings:

FIG. 1 is an exploded view of a first face mask and first secondary filter;

FIG. 2 is a schematic diagram of a user wearing the first face mask and first secondary filter of FIG. 1;

FIG. 3A is cross sectional view of a second face mask and second secondary filter;

FIG. 3B is a perspective view of the second face mask and second secondary filter of FIG. 3A;

FIG. 4A is cross sectional view of a third face mask and third secondary filter;

FIG. 4B is a perspective view of the third face mask and third secondary filter of FIG. 4A;

FIG. 5A is cross sectional view of a fourth face mask and fourth secondary filter;

FIG. 5B is a perspective view of the fourth face mask and fourth secondary filter of FIG. 5A;

FIG. 6A is cross sectional view of a fifth face mask and fifth secondary filter;

FIG. 6B is a perspective view of the fifth face mask and fifth secondary filter of FIG. 6A;

FIG. 7A is cross sectional view of a sixth face mask and sixth secondary filter;

FIG. 7B is a perspective view of the sixth face mask and sixth secondary filter of FIG. 7A;

FIG. 8A is cross sectional view of a seventh face mask and seventh secondary filter;

FIG. 8B is a perspective view of the seventh face mask and seventh secondary filter of FIG. 8A; and

FIG. 9 is perspective exploded view of a prior art face mask with a first front shell;

FIG. 10 is a perspective view of a second front shell;

FIG. 11 is a side elevation view of the second front shell of FIG. 10;

FIG. 12 is a front elevation view of the second front shell of FIG. 10;

FIG. 13 is a perspective view of a third front shell;

FIG. 14 is a side elevation view of the third front shell of FIG. 13;

FIG. 15 is a front elevation view of the third front shell of FIG. 13;

FIG. 16 is a perspective view of an eighth face mask apparatus having a fourth front shell;

FIG. 17 is a side elevation view of the eighth face mask apparatus of FIG. 16;

FIG. 18 is a front elevation view of the eighth face mask apparatus of FIG. 16; and

FIG. 19 is a rear perspective view of an offset member of the eighth face mask apparatus of FIG. 16.

### DETAILED DESCRIPTION

Various apparatus or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

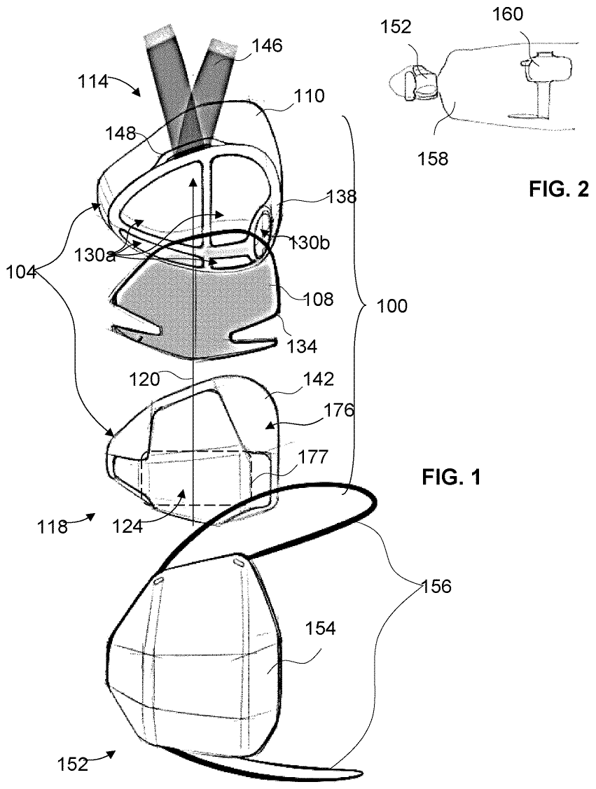

Referring now to FIG. 1, depicted is a face mask apparatus 100. Face mask apparatus 100 includes a primary face mask 104 to cover the nose and the mouth of a user. Primary face mask 104 includes a face seal 110 for providing an airtight flexible seal around the nose and mouth of the user. Face seal 110 may be formed of, for example, a soft silicone and/or a harder coating over a soft base such as a hard nylon over a silicon base.

Primary face mask 104 has a interior side 114 and a exterior side 118 opposite the interior side 114. At least one respiration passage 120 is provided through the face mask 104 between the exterior side 118 and the interior side 114. The at least one respiration passage 120 extends between at least one exterior respiration port 124 and at least one interior respiration port. In the illustrated example, the at least one exterior respiration port 124 is a single exterior respiration port 124 and the at least one interior respiration port is a plurality of interior respiration ports 130a, 130b.

The at least one respiration passage 120 includes at least one inhalation passage. In some examples, the at least one respiration passage 120 also includes at least one exhalation passage separate from the inhalation passage or partially separate from the inhalation passage. In the illustrated example, the at least one respiration passage 120 includes at least one inhalation passage extending between a single exterior respiration port 124 and a plurality of interior respiration ports 130a. The illustrated at least one respiration passage also includes an exhalation passage extending between the single exterior respiration port 124 and a single interior exhalation respiration port 130b.

In some examples, the optional at least one exhalation passage is closed by a filter and/or a vent, such as a one-way vent inhibiting flow through the exhalation passage from the exterior side 118 to the interior side 114. In some examples, a filter is received in the inhalation passage. In the illustrated example, face mask apparatus 100 includes a filter 108.

In some examples, filter 108 is a primary filter and face mask apparatus 100 is to be used also with a secondary filter. Primary filter 108 is provided for filtering air and is received in the at least one inhalation passage to filter air passing through the at least one inhalation passage. Primary filter 108 optionally filters substantially all air passing through the at least one inhalation passage. In some examples, primary filter 108 is a particulate filter. In some examples, face mask apparatus 100 is designed to filter at least 95% of 0.3 micron particles. In some examples, face mask apparatus 100 is a designated N95 mask.

In some examples, the primary filter 108 is sealingly received in the at least one inhalation passage to filter all air passing through the inhalation passage. In some examples, a perimeter of the primary filter 108 is sealed against a wall of the inhalation passage around an entire periphery 134 of the filter. In some examples, the primary face mask 104 includes a flexible primary filter seal in the inhalation passage to receive the primary filter 108 with a periphery of the primary filter 108 seated against the flexible primary filter seal. In some examples, the primary filter 108 includes a flexible primary filter seal around a periphery 134 of the primary filter 108 to be positioned against the wall of an inhalation passage.

A primary filter 108 may be a sheet filter, as in the illustrated example, or a shaped filter such as a pleated filter. A primary filter 108 may optionally be provided as a replaceable cartridge, including a supporting primary filter frame. A replaceable cartridge may include a cartridge retaining feature, such as a snap fit member, to cooperate with a primary face mask retaining feature, such as a snap fit member, to removably retain the cartridge in the at least one inhalation passage.

In the illustrated example, the primary filter 108 is a sheet filter and does not include a supporting primary filter frame. Illustrated face mask 104 includes a support 138 bearing the face seal 110. Face mask 104 also includes a front shell 142. One or both of the support 138 and the front shell 142 may be formed of a firm material such as a rigid or semi-rigid plastic. Illustrated primary filter 108 is received between the support 138 and the front shell 142. The illustrated front shell 142 can be releasably secured to the support 138. At least a portion of the primary filter perimeter 134 can be held between the support 138 and the front shell 142 to retain the primary filter 108 in the at least one inhalation passage. One or both of the primary filter 108 and the primary face mask 104 may include a primary filter seal, such as a bead of soft silicone, to further inhibit air from bypassing the primary filter 108 when moving through the at least one inhalation passage.

In some examples, the primary face mask 104 may be used with a head strap to hold the mask to the head of a user. In the illustrated example, a head strap 146 is secured to primary face mask 104. Head strap 146 may be passed around a head of a user to hold the face mask apparatus 100 to the head of the user. In the illustrated example, the head strap 146 is secured to the face mask apparatus 100 by passing through clasps 148 of support 138 of face mask 104.

In some examples, a primary face mask may be used with a secondary face mask having a secondary filter. In some examples, the secondary filter is a replaceable filter that can be removed and replaced without removing the primary filter, such as to reduce the user's exposure to airborne contaminants. For example, a user may need to remove the secondary filter to avoid carrying contaminants on the secondary filter from a first area to a second area. The user may move from the first area such as a first room to an interim area such as a hallway, and then remove a first secondary filter and apply a second secondary filter before moving from the interim area into a second area such as a second room. In some examples, the act of removing a first secondary filter may itself release contaminants from the first secondary filter into the air.

In some examples, the primary filter is also provided to bolster the effect of the secondary filter. For example, a primary filter may be a high-quality filter to protect the user while the secondary filter may be a surgical mask to capture droplets, such as cough droplets, to prevent the droplets from being deposited on the face mask. In some examples, a primary face mask with a primary filter may be a certified N95 mask, and the secondary mask with a secondary filter may be applied to the face mask to protect the face mask from droplets and/or other airborne contaminants. In some examples, a secondary filter and/or secondary mask may prevent droplets which escape the face mask, such as via an exhalation port, since droplets would be caught in the secondary filter and/or secondary mask as well.

In some examples, a secondary mask may be applied over the primary face mask and/or in the inhalation passage. In the illustrated example of FIG. 1, secondary filter 152 is a surgical mask which may be worn over the face mask apparatus 100 and includes a filter sheet 154 and a pair of ear loops 156.

In some examples, the at least one exterior inhalation port 124 is spread across a substantial portion of the forward surface 176 of the face mask apparatus 100, as in the illustrated example. In some examples, the at least one exterior inhalation port 124 is limited to a small portion of the forward surface 176 of the face mask, such as limited to a leading portion 177 of the forward surface 176. In some examples, the at least one inhalation port 124 is limited to a planar front surface extending generally perpendicular to the airflow direction. Limiting the at least one exterior inhalation port 124 to a leading portion or a planar front surface may facilitate drawing the secondary filter against the forward surface 176 over the at least one inhalation port 124 to filter air entering the at least one inhalation port.

Referring now to FIG. 2, in some examples the secondary face mask is a disposable face mask. In the illustrated example the secondary filter 152 is worn by a user 158 over the primary face mask. The user 158 also carries a pouch 160 of extra secondary face masks.

In some examples, a secondary receiver is provided on an exterior surface of a front shell of a primary face mask to receive a secondary mask and/or secondary filter. In some examples, a secondary filter receiver is a protruding and/or projecting receiver. In some examples, a receiver includes at least one of a mounting feature, a standoff, and a receiver seal.

In some examples, a receiver includes a mounting feature for mounting the secondary mask to the front shell. Examples of mounting features include snap-fit members, bump interfaces, hook and loop members, and magnetic members. A mounting feature may also be provided to inhibit movement of a secondary filter and/or secondary mask relative to the face mask. Particularly where the face mask includes a hard forward surface the secondary filter may easily slide against the hard forward surface, which may result in an undesirable positioning of the secondary filter.

In some examples, a receiver includes a standoff to maintain an air gap between the exterior surface of the front shell and the secondary mask. Examples of standoffs include projecting ribs and wire frames. In some examples, a standoff keeps the secondary mask and/or secondary filter a small distance from the exterior surface of the front shell to allow air to more freely move across the exterior surface of the front shell under the secondary mask and/or secondary filter.

In some examples, a receiver includes a receiver seal for providing an airtight flexible seal between the secondary mask and the exterior surface of the front shell around the inlet holes. Examples of receiver seals include silicone ribs and continuous silicone beads. In some examples, a receiver seal helps prevent air from bypassing a secondary filter when passing into the face mask. Air bypassing the secondary filter may reduce the effectiveness of the secondary filter in filtering air.

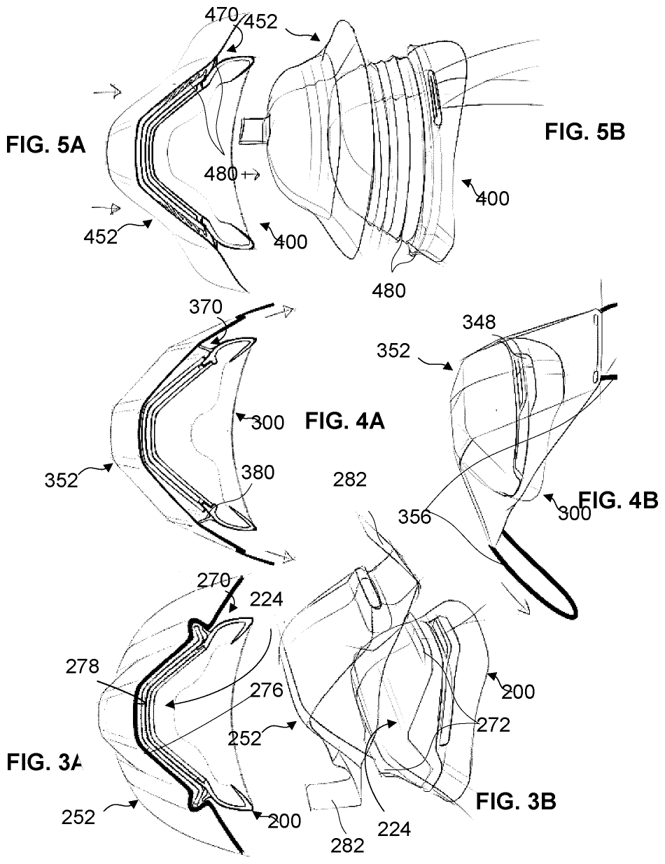

Referring now to FIGS. 3A and 3B, illustrated is a face mask apparatus 200 with a secondary filter receiver 270 on the primary face mask exterior side. Face mask apparatus 200 and secondary filter 252 are similar in many respects to face mask apparatus 100 and secondary filter 152, and like features are identified by like reference numbers incremented by 100.

In some examples, a secondary filter receiver 270 includes at least one mounting member for use in holding the secondary filter to the face mask. Secondary filter receiver 270 of face mask apparatus 200 includes a pair of lateral side mating components 272 as mounting members. A compression molded secondary filter 252 may be designed to accommodate mating components on the mask. The compression molded secondary filter 252 may be made of a stiff, deformable material to be shaped by a user to fit over the face mask apparatus 200. In some examples, a compression molded secondary filter 252 includes a material which may be manually shaped by a user. In some examples, a compression molded secondary filter 252 is stamped to shape using a stamping machine. In some examples, the natural tension of the secondary filter 252 may allow it to stretch and snap over the pair of lateral side mating components 272, causing the secondary filter 252 to be held in place on the face mask apparatus 200. In some examples, a compression molded filter forms a compression molded secondary filter mask. In some examples, a secondary filter mask formed of a compression molded filter does not include any secondary coupling features. For example, a compression molded filter mask may not include an elastic or a metal clip to be used to secure the compression molded filter mask to a face mask apparatus. In some examples, a compression molded filter mask is formed of a single sheet of compression molded material, and may be a stamped compression molded filter mask. In some examples, a compression molded filter mask formed of a single sheet of compression molded material allows for more rapid manufacturing and/or less waste during manufacturing.

The face mask apparatus 200 and/or secondary filter receiver 270 may include a forward exterior surface 276 which matches an interior surface 278 of the secondary filter 252 or which the secondary filter 252 may be compression molded to match. The secondary filter 252 may then seal to the face mask apparatus 200 by neatly overlaying the forward exterior surface 276. Portions of the secondary filter 252 are stretched over the lateral side mating components 272 and held behind the lateral side mating components 272 to hold the secondary filter 252 against the forward exterior surface 276.

In some examples, the secondary filter receiver 270 may also or alternatively include a raised periphery surrounding the at least one exterior inhalation port 224. The raised periphery may be a continuous flexible rib or rim of a flexible material such as silicone or rigid plastic. The raised secondary filter sealing member may also or alternatively be a bead of a flexible material forming a raised surface that the secondary filter 252 may be pressed into to inhibit air passing into the at least one exterior inhalation port 224 without first passing through the secondary filter 252.

Illustrated secondary filter 252 includes at least one pull tab 282 to provide a gripping area for use in pulling the secondary filter 252 on or off of the face mask apparatus 200. In some examples, at least one pull tab 282 may assist in minimizing contact between the fingers a user and the secondary filter 252 during removal of the secondary filter.

Referring now to FIGS. 4A and 4B, illustrated is a face mask apparatus 300 with a secondary filter receiver 370 on the primary face mask exterior side. Face mask apparatus 300 and secondary filter 352 are similar in many respects to face mask apparatus 200 and secondary filter 252, and like features are identified by like reference numbers incremented by 100.

In the illustrated example, secondary filter receiver 370 is a flexible rib 380, such as a silicone rib, and the secondary filter 352 is held to a head of a user by ear loops 356 which draw the secondary filter 352 against the face mask apparatus 300 and the secondary filter receiver 370. Secondary filter 352 may be a standard surgical mask or may be shaped for the face mask apparatus 300 to avoid air gaps between the secondary filter 352 and the flexible rib. For example, the secondary filter 352 may be shaped to fit more easily over clasps 348 of mask 300. In some examples, secondary filter 352 is a compression molded filter that may be stamped to shape. In some examples, secondary filter 352 is cut to form over the base mask under tension. In some examples, secondary filter 352 is pleated or darted with sonic welded joints to be tailored to fit the base mask.

Referring now to FIGS. 5A and 5B, illustrated is a face mask apparatus 400 with a secondary filter receiver 470 on the exterior side. Face mask apparatus 400 and secondary filter 452 are similar in many respects to face mask apparatus 300 and secondary filter 352, and like features are identified by like reference numbers incremented by 100.

Illustrated secondary filter 452 is a compression molded filter formed of a stiff moldable material to allow a user to shape the filter over the face mask apparatus 400. The face mask apparatus 400 includes a series of flexible silicone ribs 480 which create a multi-layered seal with the compression molded filter 452. The series of flexible silicone ribs 480 are also mounting members and assist in holding the secondary filter 452 on in a friction fit. In some examples, a secondary filter receiver assists in preventing fogging of eyewear. For examples, ribs 480 inhibit movement of air through a gap between the face mask 400 and the secondary filter 452 and thereby help prevent fogging of eyewear adjacent the face mask 400.

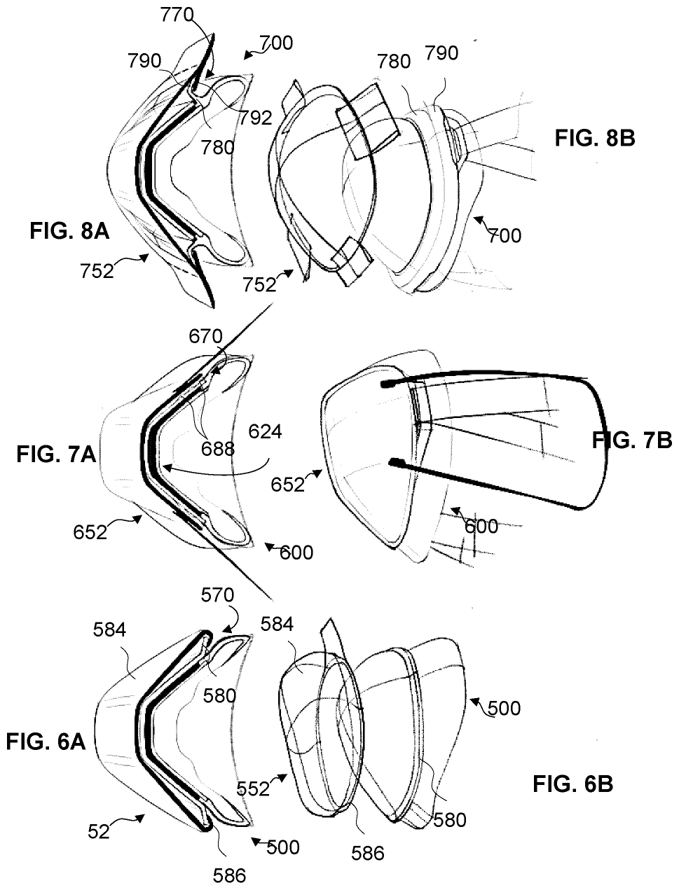

Referring now to FIGS. 6A and 6B, illustrated is a face mask apparatus 500 with a secondary filter receiver 570 on the primary face mask exterior side. Face mask apparatus 500 and secondary filter 552 are similar in many respects to face mask apparatus 400 and secondary filter 452, and like features are identified by like reference numbers incremented by 100.

Secondary filter receiver 570 of face mask apparatus 500 includes a raised periphery 580. Secondary filter 552 is a flexible material sheet 584 with a perimeter elastic 586. Similar to the way in which a perimeter elastic of a hair net may be stretched over a retaining feature, the perimeter elastic 586 may be stretched over raised periphery 580. Raised periphery 580 is therefore both a mounting member and provides a filter seal between the primary face mask and the secondary filter 552. In some examples, the primary face mask of face mask apparatus 500 includes a foam or silicone track in which the elastic 586 may rest to allow the tension of the elastic 586 to create a seal between the secondary filter 552 and the mask 500.

Referring now to FIGS. 7A and 7B, illustrated is a face mask apparatus 600 with a secondary filter receiver 670 on the primary face mask exterior side. Face mask apparatus 600 and secondary filter 652 are similar in many respects to face mask apparatus 500 and secondary filter 552, and like features are identified by like reference numbers incremented by 100.

In the illustrated example, the secondary filter receiver 670 includes a set of continuous raised beads of silicone 688 surrounding the at least one exterior inhalation port 624 for providing a filter seal between the primary face mask and the secondary filter 652. Secondary filter 652 is a mask having ear loops to hold the mask against a head of a user and against the beads of silicone 688.

Referring now to FIGS. 8A and 8B, illustrated is a face mask apparatus 700 with a secondary filter receiver 770 on the primary face mask exterior side. Face mask apparatus 700 and secondary filter 752 are similar in many respects to face mask apparatus 600 and secondary filter 652, and like features are identified by like reference numbers incremented by 100.

Secondary filter receiver 770 of face mask apparatus 700 includes a raised periphery 780. Raised periphery 780 includes an outwardly directed flange 790. Secondary filter 752 includes a lip 792 which may fit under outwardly directed flange 790 to assist in retaining secondary filter 752 on face mask apparatus 700.

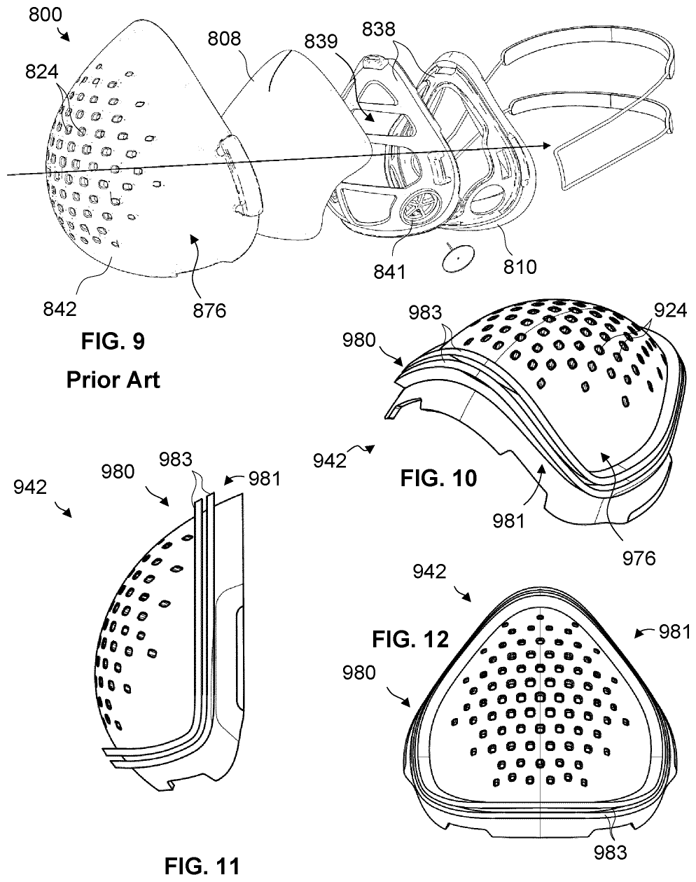

Referring now to FIG. 9, illustrated is a prior art face mask apparatus 800 disclosed in Patent Application Publication WO 2018/045456 filed by the present Applicant. Face mask apparatus 800 is similar in many respects to face mask apparatus 100, and like features are identified by like reference numbers incremented by 100.

Face mask apparatus 800 is a face mask apparatus for filtering air. Face mask apparatus 800 includes a face seal 810 for providing an airtight flexible seal around the nose and mouth of the user.

Face mask apparatus 800 also includes a support sealably attached to the face seal wherein the support 838 has an open area 839 that allows for passage of incoming air and outlet valves 841 for expelling exhaled air. Face mask apparats 800 also includes a front shell 842 for removably attaching to the support 838. The front shell 842 has inlet holes 824 in the exterior surface 876 for allowing the incoming air to pass through the open area 839 of the support 838.

Face mask apparatus 800 also includes a filter 808 for filtering particulate elements from air. The filter 808 is configured to be housed between the front shell 842 and the support 838. The face seal 810 provides a direct connection between the filter 808 and the user.

Referring now to FIGS. 10 to 12, illustrated front shell 942 is similar in many respects to front shell 842, and like features are identified by like reference numbers incremented by 100. Illustrated front shell 942 includes a filter receiver 980 projecting from an exterior surface 976 of the front shell 942 for receiving a secondary mask.

Illustrated filter receiver 980 includes a receiver seal 981 for providing an airtight flexible seal between the secondary mask and the exterior surface 976 of the front shell 942 around the inlet holes 924. Illustrated receiver seal 981 includes a pair of continuous flexible ribs 983.

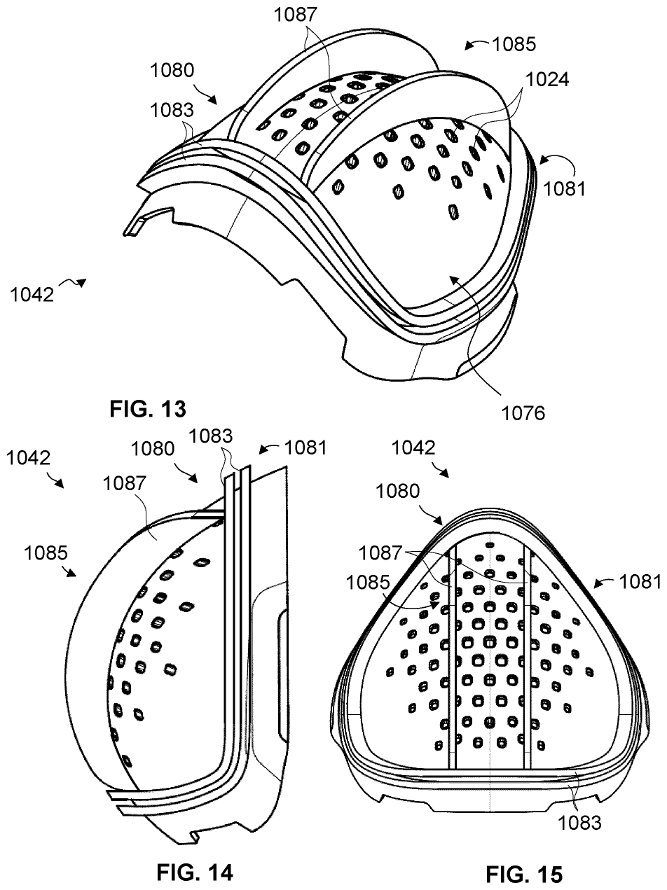

Referring now to FIGS. 13 to 15, illustrated front shell 1042 is similar in many respects to front shell 942, and like features are identified by like reference numbers incremented by 100. Illustrated front shell 1042 includes a receiver 1080 projecting from an exterior surface 1076 of the front shell 1042 for receiving a secondary mask.

Illustrated receiver 1080 includes a receiver seal 1081 for providing an airtight flexible seal between the secondary mask and the exterior surface 1076 of the front shell 1042 around the inlet holes 1024. Illustrated receiver seal 1081 includes a pair of continuous flexible ribs 1083.

Illustrated receiver 1080 also includes a standoff 1085 for maintaining an airflow gap between the exterior surface of the front shell and the secondary mask. Illustrated standoff 1085 includes a pair of raised ribs 1087 to hold the secondary mask and/or secondary filter away from the exterior surface 1076.

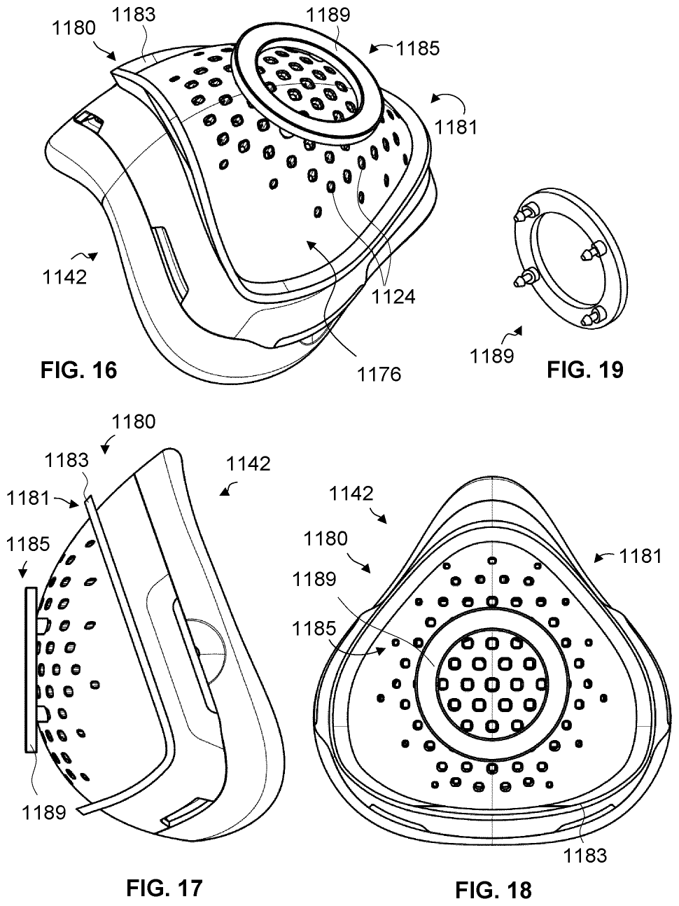

Referring now to FIGS. 16 to 18, illustrated front shell 1142 is similar in many respects to front shell 1042, and like features are identified by like reference numbers incremented by 100. Illustrated front shell 1142 includes a receiver 1180 projecting from an exterior surface 1176 of the front shell 1142 for receiving a secondary mask.

Illustrated receiver 1180 includes a receiver seal 1181 for providing an airtight flexible seal between the secondary mask and the exterior surface 1176 of the front shell 1142 around the inlet holes 1124. Illustrated receiver seal 1181 includes a continuous flexible rib 1183.

Illustrated receiver 1180 also includes a standoff 1185 for maintaining an airflow gap between the exterior surface of the front shell and the secondary mask. Illustrated standoff 1185 includes a detachable offset member 1189 to hold the secondary mask and/or secondary filter away from the exterior surface 1076. Offset member 1189, shown in greater detail in FIG. 19, may come in a variety of shapes and be detectably mountable to the front shell 1142. In the illustrated example, offset member 1189 includes snap-fit legs to fit into inlet holes 1124 and has a circular forward portion with a flat leading surface. In some examples, the offset member may have a square forward portion and/or have an arched leading surface.

In some examples, a standoff and/or offset member may include a non-smooth surface to prevent the secondary filter and/or secondary mask from sliding across the front shell 1142. In some examples, a standoff and/or offset member may include a silicone leading surface.

The present invention has been described here by way of example only. Various modification and variations may be made to these exemplary embodiments without departing from the scope of the invention, which is limited only by the appended claims.

1. A face mask apparatus for filtering air, the face mask apparatus comprising:
a face seal for providing an airtight flexible seal around the nose and mouth of the user;
a support sealably attached to the face seal, wherein the support has an open area that allows for passage of incoming air and outlet valves for expelling exhaled air;
a front shell for removably attaching to the support, wherein the front shell has at least inlet holes for allowing the incoming air to pass through the open area of the support;
a filter for filtering particulate elements from air, wherein the filter is configured to be housed between the front shell and the support, and the face seal provides a direct connection between the filter and the user; and
a receiver projecting from an exterior surface of the front shell for receiving a secondary mask.

2. The face mask apparatus of claim 1, wherein the receiver includes a mounting feature for mounting the secondary mask to the front shell.

3. The face mask apparatus of claim 1, wherein the receiver includes a standoff for maintaining an airflow gap between the exterior surface of the front shell and the secondary mask.

4. The face mask apparatus of claim 1, wherein the receiver includes a receiver seal for providing an airtight flexible seal between the secondary mask and the exterior surface of the front shell around the inlet holes.

5. The face mask of claim 4, wherein the receiver seal is a continuous flexible raised periphery

6. A face mask apparatus for filtering air, the face mask apparatus comprising:
a face seal for providing an airtight flexible seal around the nose and mouth of the user;
a support sealably attached to the face seal, wherein the support has an open area that allows for passage of incoming air;
a front shell for removably attaching to the support, wherein the front shell has at least one inlet hole for allowing the incoming air to pass through the open area of the support;
a filter for filtering particulate elements from air, wherein the filter is configured to be housed between the front shell and the support, and the face seal provides a direct connection between the filter and the user; and
a receiver projecting from an exterior surface of the front shell for receiving a secondary mask.

7. The face mask apparatus of claim 6, wherein the receiver includes a mounting feature for mounting the secondary mask to the front shell.

8. The face mask apparatus of claim 6, wherein the receiver includes a standoff for maintaining an airflow gap between the exterior surface of the front shell and the secondary mask.

9. The face mask apparatus of claim 6, wherein the receiver includes a receiver seal for providing an airtight flexible seal between the secondary mask and the exterior surface of the front shell around the at least one inlet hole.

10. The face mask of claim 9, wherein the receiver seal is a continuous flexible raised periphery.

11. A face mask apparatus for filtering air, the face mask apparatus comprising:
a face seal for providing an airtight flexible seal around the nose and mouth of the user;
a support sealably attached to the face seal, wherein the support has an open area that allows for passage of incoming air;
a front shell for removably attaching to the support, wherein the front shell has at least one inlet hole for allowing the incoming air to pass through the open area of the support;
a filter for filtering particulate elements from air, wherein the filter is configured to be housed between the front shell and the support, and the face seal provides a direct connection between the filter and the user; and
a secondary filter releasably secured to an exterior surface of the front shell and disposed upstream of the at least one inlet hole to pre-filter an air flow entering the inlet hole.

12. The face mask apparatus of claim 11, further comprising a receiver projecting from the exterior surface of the front shell for receiving the secondary filter.

13. The face mask apparatus of claim 12, wherein the receiver includes a mounting feature for mounting the secondary filter to the front shell.

14. The face mask apparatus of claim 12, wherein the receiver includes a standoff for maintaining an airflow gap between the exterior surface of the front shell and the secondary filter.

15. The face mask apparatus of claim 12, wherein the receiver includes a receiver seal for providing an airtight flexible seal between the secondary filter and the exterior surface of the front shell around the at least one inlet hole.

16. The face mask of claim 15, wherein the receiver seal is a continuous flexible raised periphery.

17. The face mask of claim 11, wherein the secondary filter is a compression molded filter mask.

18. A filtration method, comprising:
applying a face mask apparatus to a face of a user, the face mask apparatus including a primary face mask to cover a nose and a mouth of the user and having a face seal for providing an airtight flexible seal around the nose and mouth of the user, the face mask apparatus including an inhalation passage through the face mask apparatus, a primary filter received in the inhalation passage to filter air passing through the inhalation passage;
applying, while maintaining the face mask apparatus on the face of the user and the primary filter in the inhalation passage to filter air passing through the inhalation passage, a first secondary filter to the face mask apparatus to filter air prior to the air passing through the inhalation passage;
removing, while maintaining the face mask apparatus on the face of the user and the primary filter in the inhalation passage to filter air passing through the inhalation passage, the first secondary filter and disposing of the first secondary filter; and
applying, while maintaining the face mask apparatus on the face of the user and the primary filter in the inhalation passage to filter air passing through the inhalation passage, a second secondary filter to the face mask apparatus to filter air prior to the air passing through the inhalation passage.

19. The filtration method of claim 18, wherein applying the first secondary filter to the face mask includes covering a forward exterior surface of the face mask apparatus with the first secondary filter.

20. The filtration method of claim 19, wherein applying the second secondary filter to the face mask includes covering the forward exterior surface of the face mask apparatus with the second secondary filter.
